(19) United States
(12) Patent Application Publication
(10) Pub. No.: US 2003/0187971 A1
(43) Pub. Date: Oct. 2, 2003

(54) Enterprise macro-manager of contact center communications technologies

(76) Inventors: Anthony X. Uliano, Richmond, VA (US); Andrew Raymond, Oceanside, CA (US); Glenn Abel, Crozier, VA (US)

Correspondence Address: JOHN H. THOMAS, P.C., 1561 EAST MAIN STREET, RICHMOND, VA, 23219, US

(21) Appl. No.: 10/113,544

(22) Filed: Mar. 29, 2002

(51) Int. Cl. G06F 15/173

(52) U.S. Cl. 709/223

(57) ABSTRACT

A method and system manages enterprise communications where an enterprise receives communications data from a plurality of communications technologies. For each communications technology, data from that technology is converted to a common interface data. That interface data is then managed including creating a combined queue of communications data from the communications technologies. The managed interface data is then delivered to any application in the enterprise.

The present invention relates to the coordination of multiple contact center communications technologies. Specifically, the invention relates to converting data from each enterprise communications technology into a common interface data, and then managing that data before delivering it to any contact center application in an enterprise.

### BACKGROUND OF THE INVENTION

Traditionally, businesses or other organizations that handle customer phone calls have done so independently of the computer applications that a customer service representative (CSR) would use to process the customer's request or concern. A customer would place a call into the organization which would be transferred to a CSR. The CSR's phone would ring; they would ask the customer for information that could be used to identify the customer within the computer application (customer ID, Social Security Number, home phone number, etc.). The CSR would enter this customer information, verify the customer identity, and then proceed to process the customer's request. The telephone and the computer application were separate tools, only joined together by an intelligent CSR agent (see FIG. 1).

Because of the large volume of telephone calls and the amount of time required to handle each call, organizations looked for ways to reduce the overall time a CSR spent on each call. By reducing the amount of time a CSR spent on each call, less agents were needed, or agents could spend time doing other tasks. In a typical call center, reducing each call by 5 seconds could generate thousands of dollars of savings.

PBX (telephone switch) companies quickly began offering proprietary CTI (computer telephony integration) servers that would connect to the PBX's they offered and provide certain information in advance of the call being delivered. Any data that could be sent before the call was delivered to the CSR would save the CSR the time it would take to request it from the customer. For example, since the PBX could determine the ANI (Automatic Number Identification) of the caller (similar to Caller ID) before the call was sent to an agent, the CTI server would use the ANI and search a database for the customer information (name, address, etc.). Once it found the name, the CTI server would be told what CSR the call was being routed to, the customer information would be sent to the computer screen before the call arrived. This advance customer information saved the CSR the time it would take to perform the lookup, which ultimately saved money on each call.

In addition to providing advance customer information before the call was delivered, CTI servers would also allow a CSR to perform certain telephone functions from the computer application rather than pressing the button on the phone. For example, the CSR could put a customer on holdby sending the “hold” command from the computer application to the CTI Server, which, in turn, instructed the PBX to put the customer on hold. Since the CSR would already be using the computer keyboard to process the customer request, companies found it more efficient for the CSR to send the hold command through the computer application than by physically moving from the computer keyboard to the telephone pad to place the call on hold. FIG. 2 illustrates the first simple computer telephony integration scenario. The CTI Server₁ was customized to work with a corresponding, specific PBX₁.

Once the cost savings of CTI became apparent, all of the major PBX vendors began offering proprietary CTI servers. Several non-PBX vendors also entered the market with CTI servers of their own. Companies like Genesys Telecommunications, HP, and IBM offered products to customers that would integrate with other vendors' PBX hardware. These non-PBX vendors are commonly referred to as CTI Middleware providers.

A major advantage that the CTI Middleware companies had over PBX CTI Servers was their ability to talk to multiple PBXs, even if the PBXs were from different vendors. Customers that had different PBX hardware from different vendors at different sites could purchase the CTI server from a CTI Middleware company and be able to communicate with each PBX.

AMC Technology, L.L.C. built its first product, the Telephony Connector, to address the needs of enterprises to integrate their software applications with CTI Servers. AMC's Telephony Connector connects software applications to CTI servers provided by either PBX vendors or CTI Middleware companies. More information is available at www.amctechnology.com. This product, and others like it, addresses the issues of various enterprise applications and their interaction with the many CTI servers available.

During the period where both CTI Middleware vendors and PBX vendors were offering CTI servers, enterprises were expanding the ways they communicate with customers. Although communication over the telephone made up the majority of customer to enterprise communication, other communication methods were being used. Customers started using e-mail and the World Wide Web (internet) to make requests in addition to the telephone.

In response to their evolving needs, enterprises began purchasing software that would allow them to communicate with customers over e-mail and the Internet. Typically, enterprises purchased stand-alone e-mail systems and stand-alone Internet servers. In large companies, sometimes many different e-mail systems and Internet servers would be purchased. Across a single company's enterprise, it is common to have many different stand-alone e-mail systems, stand-alone Internet servers, and PBX hardware from many different vendors. The CTI Middleware vendors and, to a lesser extent, the PBX vendors enhanced their CTI servers by building their own proprietary and customized e-mail systems and Internet servers. CTI Servers, therefore, migrated to support all three methods of communication (telephone, e-mail, internet). FIG. 3 illustrates a Multi-Channel CTI Server.

Many enterprises purchased Multi-Channel CTI Servers and added them to the already existing heterogeneous environments. These environments were made up of many stand-alone e-mail systems, Internet systems, PBXs from many different vendors, and also CTI servers that support PBX-only communication and Multi-Channel CTI Servers. It would not be surprising to find an enterprise with 25 different products from 25 different vendors across 25 different sites. These companies with many different products from many different vendors have no way of managing all of them as a seamless communication infrastructure.

### SUMMARY OF THE INVENTION

Accordingly, the present invention was developed to solve the foregoing problems of managing a heterogeneous collection of communications technologies. An enterprise macro-manager is provided in the form of a central management server that can be configured to talk to a variety of communication products and that allows an enterprise to coordinate customers communicating through all these different products to be treated as one seamless communication infrastructure.

In one embodiment, the invention is a method for managing enterprise communications wherein the enterprise receives communications data from a plurality of communications technologies. The method comprises the step of, for each communications technology, converting the data from each technology to a common interface data. It also includes the steps of managing the interface data including creating a combined queue of communications data from communications technologies, and delivering the managed interface data to any application in the enterprise. The combined queue of communications data may be a universal queue of communications data from all communications technologies. Alternatively, the combined queue of communications data may be combination of queues from similar communications technologies. The communications technologies may comprise different vendor technologies or similar communications technologies. Each communications technology may have its own queue management functionality before the creation of a combined queue. Alternatively, if at least one of the communications technologies does not have its own queue management functionality, the step of creating a combined queue includes assigning queue management functionality to each communications technology that does not already have it. Also, the enterprise may comprise a plurality of applications, and the method further comprises receiving data from any application in the enterprise and making that data available to one or more of the other applications.

In a further embodiment, the invention includes a system for managing enterprise communications wherein the enterprise receives communications data from a plurality of communications technologies. This system comprises an enterprise macro-manager. The enterprise macro-manager further comprises communications technology connectors adapted to convert data from each technology to a common interface data, at least one management services module that manages the interface data, and user links adapted to connect the managed data to at least one enterprise application. The management services module may create a combined queue of communications data from the communications technology. The combined queue of communications data may be a universal queue of communications data from all communications technology. Alternatively, the combined queue of communications data may be a combination of queues from similar communications technologies. The communications technologies may comprise different vendor technologies or may comprise similar communications technologies. Each communications technology may have its own queue management functionality before the creation of a combined queue.

### BRIEF DESCRIPTION OF THE DRAWINGS

FIGS. 1-3 are all schematic representations of prior art call center technology.

FIG. 4 is a schematic flow chart illustrating the claimed invention and the interaction between communications technologies and enterprise contact centers.

FIG. 5 is a schematic flow chart illustrating the components of the enterprise macro-manager claimed herein.

FIG. 6 is a flow chart demonstrating the flow of information through the claimed invention.

FIG. 7 is a flow chart illustrating the operation of a communications technology connector.

FIG. 8 is a generic inbound contact flow chart.

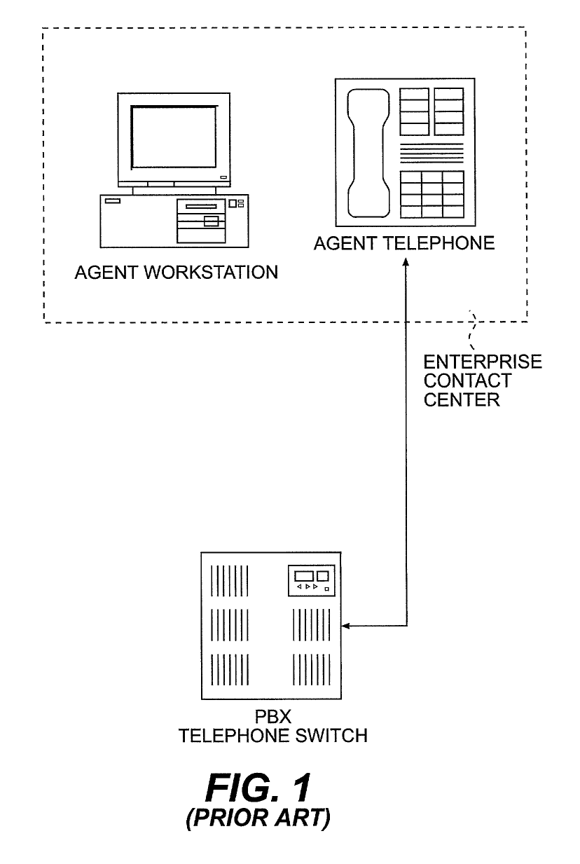

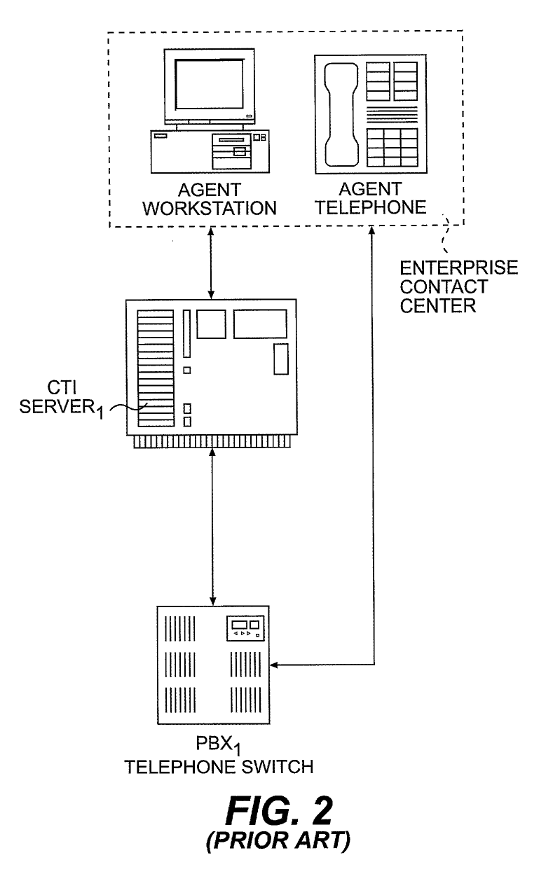

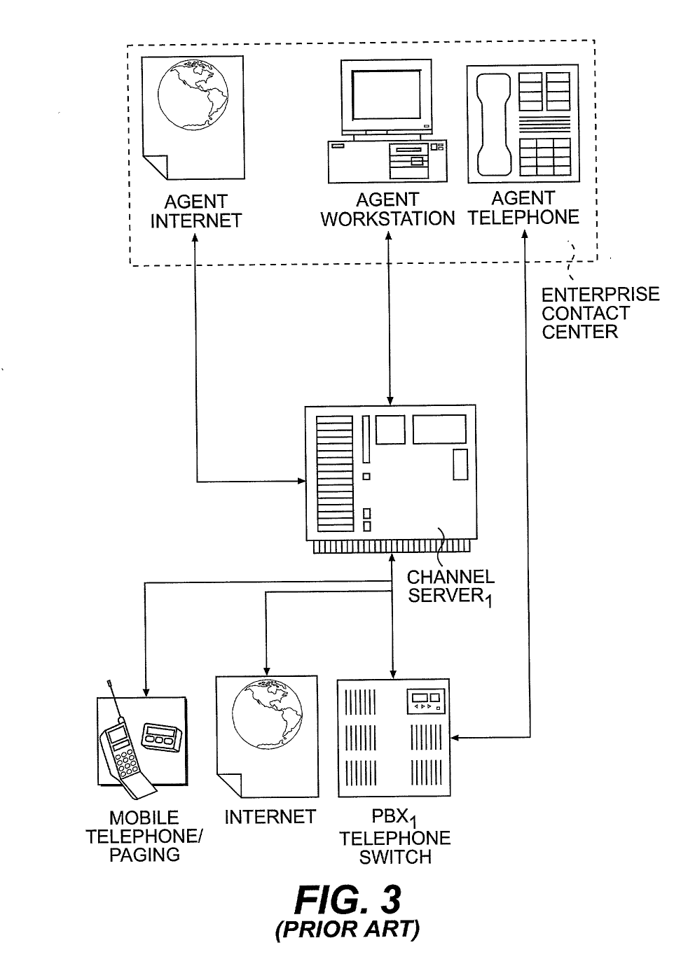

### DETAILED DESCRIPTION

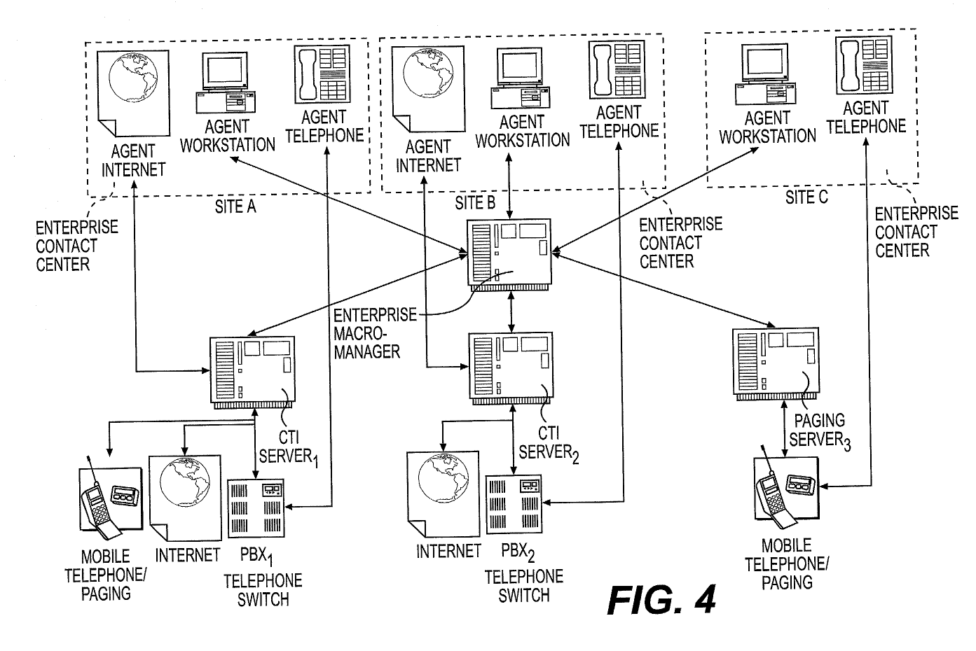

The present invention is a macro-manager of all enterprise communications technologies. That is, an enterprise contact center is provided with a single, seamless communication infrastructure regardless of the multiple communications technologies from multiple vendors that exist in its system. The present invention simplifies the many and proprietary communications technologies that would otherwise require many separate communications infrastructures. Referring to FIG. 4, instead of the enterprise macro-manager shown, an enterprise would require at least three different infrastructures to work with CTI Server₁, CTI Server₂, and Paging Server₃. In fact, as noted earlier, it is not uncommon to find dozens of different communications technologies for a single enterprise to handle.

The term communications technology as described herein has a broad definition. It includes multiple categories of communications devices, e.g., telephones, mobile telephones, e-mail, pagers, Internet, faxes, handheld computing devices, web chat, instant message, wallboard, etc. As used herein, “similar” communications technology shall refer to devices that are available within each of the categories of communications devices. In the broad sense again, communications technologies further include different types and generations of the actual hardware and software within the foregoing ranges of devices. It still further includes different vendors and their different hardware and software within the range of the foregoing devices and management of those devices. It further includes prior servers that combine the management of some subset of the devices, typically in the format of a still further proprietary technology. All of these known and existing combinations of technology are limited in nature as described earlier herein.

The present invention relates to the consolidation and management of communications between outside individuals and the enterprise itself. The enterprise macro-manager (EMM) provides an incoming and outgoing seamless communications infrastructure. The EMM is further available for uniform interaction with an application in the enterprise itself. The enterprise can and often does have multiple applications such as customer relations management, customer service, workforce management, customer support, self service, help desk, etc. Each of these applications need only interact with the EMM system to result in a coherent, uniform, seamless flow of information. There is no need for multiple independent interactions compelled by different communications technologies that result in different treatments of those technologies.

As will be explained in more detail in the examples that follow, one feature of the EMM is the ability to make a combined queue of contacts. Most communications technologies and CTI servers have existing queue functionality, but there is no integration of those functions. A combined queue may mean a universal queue in that the EMM creates a single queue of all contacts across all the communications technologies. The EMM may also, however, create one or more combined queues of subsets of all the technologies by, for example, various categories of contacts from communications technologies, subject matter, geography, etc. For instance, it could be convenient to form a queue of all e-mail or web chat or telephone calls, etc. EMM allows the enterprise to decide how to handle or prioritize various combined queues.

Another aspect of EMM is the ability to assign a queue where a particular communications technology does not have any queuing functions (whether because such a function is not inherent in the technology or because the vendor technology does not include it). Once EMM assigns a queue, then it manages the queue in the same manner as other queues from various communications technologies under the given EMM system application. So more than just handling the organization that it is given, EMM can also impart some organization (e.g. a queue) and then manage it accordingly.

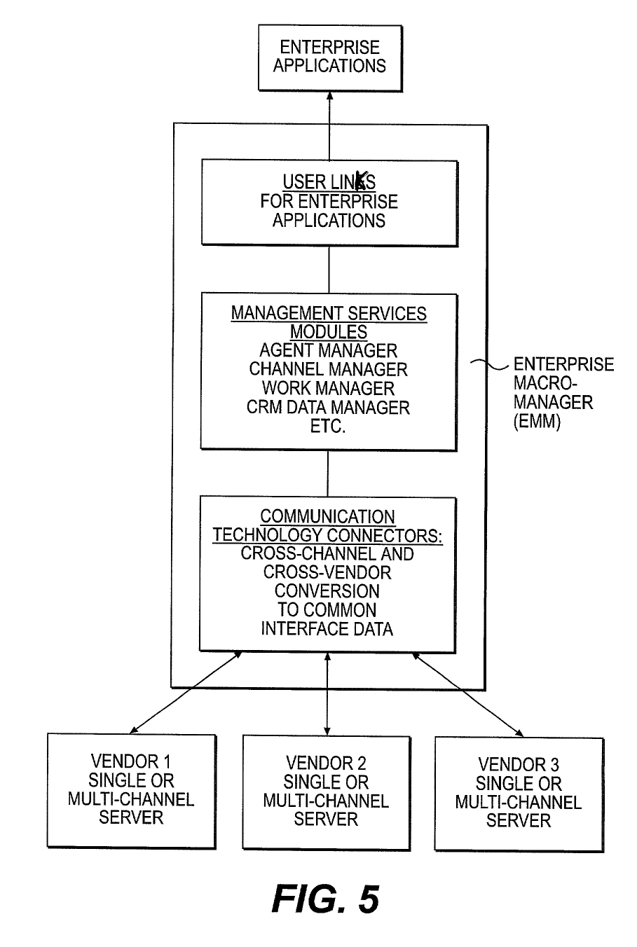

The enterprise macro-manager has three fundamental components (groups of components) as seen in FIG. 5 in a very basic flow diagram: communications technology connectors, management service modules, and links to enterprise applications.

First, there are communications technology connectors. These connectors convert data received from every communications technology, regardless of vendor or type of device, to a common interface data. The EMM is a COM-based application, and as such, is composed of a predefined set of COM objects on which it operates. COM is a Microsoft® standard method for transporting data and calling remote functions between applications. The connectors are written for each technology/vendor to convert their data inflow into the predefined COM objects and the data outflow back into the necessary data understood by each technology/vendor.

Every communications technology connector consists of three distinct layers: an EMM channel interface layer, the interface translation layer, and the vendor/product specific application programming interface (API) layer. COM-based connectors may be in-process or out-of-process servers. It is recommended that an out-of-process server approach be used. The EMM channel interface contains interface data that is mandatory for each communications technology connector implementation. The EMM channel interface also contains interface data that is specific to the communication technology supported by the communication technology. For example, for an e-mail communication technology connector, the e-mail specific EMM channel interface data needs to be implemented. The interface translation layer builds a bridge between the vendor API and EMM channel interface. The EMM channel interface requires that a communications technology connector maintain the channel state and a logical binding to the application managing the channel. The EMM channel interface delivers events and state changes for the channels initiated by managing applications, and then the vendor API delivers events and state changes initiated by the communications technology. The interface translation layer then maintains the states and bindings, mapping the states and functionality of the vendor API to the standard states and functions of the EMM, maintaining synchronization of the channel and managing application. Examples of channel state that are implemented in the EMM channel interface are: Null, Initiated, Alerting, Connected, Held, Queued, Failed, and Offered. Examples of the states implemented for managing applications are: Ready, Not Ready, Work Ready, and Work Not Ready. The vendor API layer will vary by communications technology and may implement similar functionality to what is implemented in the EMM. This is expected and is handled by the interface translation layer and EMM channel interface.

Second, the enterprise macro-manager provides a plurality of management services modules. These services include an agent manager, channel manager, work manager, enterprise data manager, and other products that could be added. All of these services work off of the common interface data from the connectors. The following are exemplary of the core modules that may be included:

Agent Dashboard Manager

The Agent Dashboard Manager is responsible for interacting synchronously and asynchronously with an enterprise contact center workstation via the Agent Dashboard Control.

Agent Manager

The Agent Manager Module is responsible for handling Agent State such as WorkMode and Queue Login/out status. It coordinates this information across all communication technologies and CTI Servers.

Data Store

The Data Store Module is responsible for handling all interface data called “Contact Associated Data”. The Data Store Module coordinates this interface data across all communication technologies and CTI Servers.

Event Manager

The Event Manager Module is responsible for managing synchronous and asynchronous events between modules.

License Manager

The License Manager Module is responsible for checking that EMM and any configured channels have the proper license for the correct number of agents.

Module Manager

The Module Manager is the parent module of all other modules. It is responsible for starting, stopping, and monitoring every module that has been configured.

Data Access Client

The Data Access Client is responsible for communication as a client to an application to send and retrieve data.

Data Access Server

The Data Access Server is responsible for allowing applications to communicate with EMM as a client.

Work Manager

The Work Manager manages the EMM queues.

Of course there could be other EMM management services modules that could be added. Some of these modules could be enhanced, streamlined, or removed altogether depending on specific requirements of an application.

Finally, the EMM includes user links to the enterprise applications. Each of the enterprise applications must include software that allows those applications to communicate with EMM. Nevertheless, it is a single adaptation that needs to be written rather than the multiple programs otherwise necessary in the case of receiving multiple communications technology data from diverse technologies. Some examples of enterprise applications include: customer relationship management, customer service, customer support, help desk, and self-service, among others. Each is discussed in further detail below.

Customer Relationship Management

Customer Relationship Management (CRM) is a relatively new type of enterprise application that is being offered to customers. The focus of CRM is to more accurately identify, track, analyze, and service a companies' customers through the use of data and advanced customer service technology. In CRM, customers need to be tracked and serviced through any communication technology. Many companies have several applications that, when combined, represent the companies° CRM application.

Customer Service

Customer Service applications are enterprise applications that are used to service a customer. Selling a product or service, maintaining customer data, and maintaining customer billing data are three typical areas of functionality included in a Customer Service enterprise application.

Customer Support

Customer Support applications are enterprise applications that are used to support a customer. Scheduling maintenance, scheduling installation, and troubleshooting product problems are three typical areas of functionality included in a Customer Support enterprise application.

Help Desk

Help Desk applications are enterprise applications that are used to support internal employees. Providing assistance with internal asset support, scheduling installation, and troubleshooting asset problems are three typical areas of functionality included in a Help Desk enterprise application.

Self-Service

Self-Service applications are enterprise applications that are provided to customers to help themselves with various company interactions, typically through the internet or automated telephone attendant. Purchasing products, researching product problems and solutions, and updating customer profiles are three typical areas of functionality included in a Self-Service enterprise application.

EMM plays a critical role in delivering interface data to each of the above-referenced applications (and any modules that could be added) through any communication technology. By using EMM, companies can significantly increase the functionality of their offering.

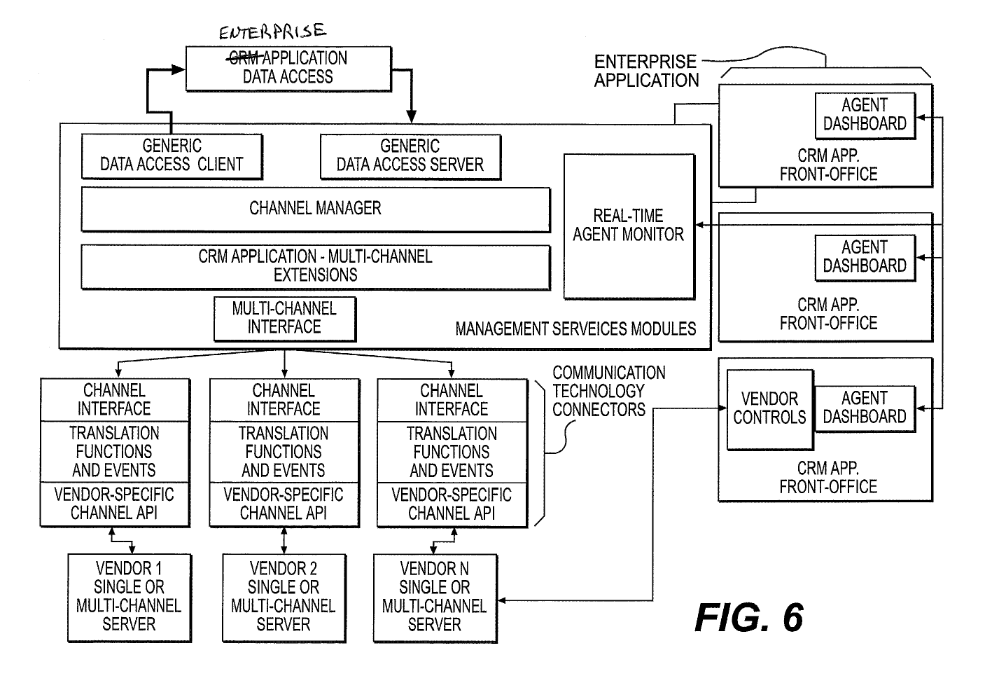

FIG. 6 is a diagram that further illustrates one embodiment of an EMM system that includes the communications technology connectors, some representative management services modules and how they link to representative enterprise applications. In order to best clarify the invention, the diagram is explicitly labelled and self-explanatory in view of the discussion herein.

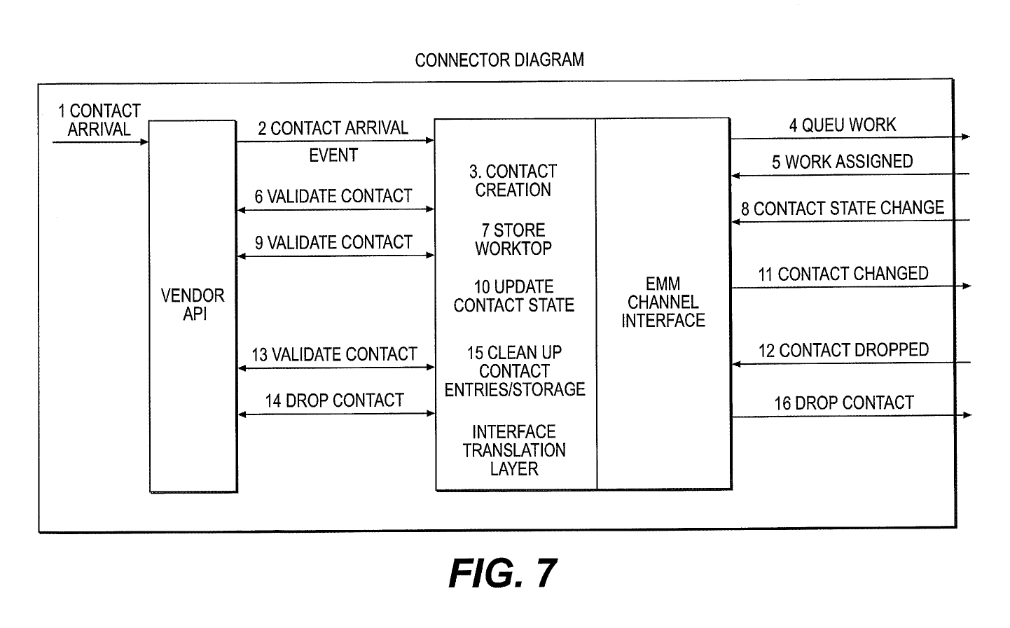

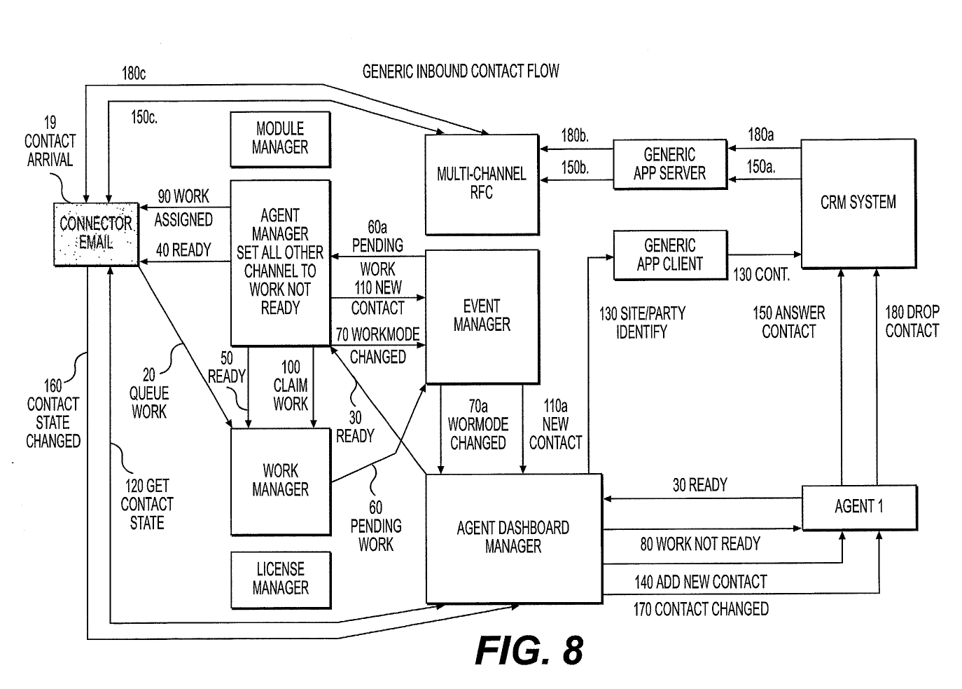

As a further demonstration of a preferred embodiment of the invention, FIGS. 7 and 8 illustrate more detailed flow charts of a connector (FIG. 7) and a representative inbound contact progression (FIG. 8). Explanations of the various numbered steps is provided herein.

Connector Flow

FIG. 7 describes an overview of the main functions that a communications technology connector provides. The overriding function is to provide translation from the vendor application programming interface (API) to the EMM channel interfaces. To properly accomplish this, the connector must maintain the internal state of a contact, maintain a handle for each contact (or create one if the API does not provide it), and maintain a session and local storage (if needed). Another key concept that must be understood is that of the worktop. The worktop is a unique identifier that is maintained within the EMM for each agents application desktop. It is used to bind a contact to an agent. A simple contact arrival and contact drop are described here and with reference to FIG. 7. The numbered steps correspond to the like-numbered aspects of FIG. 7.

1) Contact Arrival from internet/pstn/etc.

2) Vendor API delivers arrival event or appropriate call back is invoked to notify connector of contact arrival.

3) The interface translation layer will then create the needed storage for the contact, updating internal contact state, and storing the contact handle (or creating a handle if one does not exist).

4) The Work Manager module within the EMM Server is then sent a Queue Work request for the new contact (via the EMM channel interface) providing the contact handle. This initiates the needed queuing and agent identification within the EMM Server.

5) The server will then return a “Work Assigned” event to the EMM channel interface, indicating that an agent is assigned the contact. The associated worktop is returned with the contact handle.

6) Contact state is validated.

7) If the contact is no longer valid (Call dropped, etc.) the proper events would be sent to EMM via the EMM Channel Interface for dropping the contact. Otherwise the worktop is stored. Once the contact has been work assigned, the connector's responsibility shifts to “Event Processing”. This includes processing all solicited and unsolicited events and function calls that indicate a change in the state of a contact from either the vendor API or the EMM server via the EMM channel interface. For sake of this call flow we will assume that the call will be answered by an agent and will then be dropped by the agent.

8) A Contact state changed event for contact answer arrives from EMM.

9) The state of the contact is validated.

10) The internal contact state is updated in the interface translation layer. If the contact had not been validated (i.e. connection dropped, etc.) the connector would have raised the appropriate event to notify EMM.

11) The connector then notifies the dashboard that the state successfully changed via a Contact Changed so the agent dashboard can be updated.

12) The agent then drops the contact. The EMM delivers a contact dropped event to the EMM channel interface.

13) The interface translation layer initiates a check of the internal contact state.

14) Given the contact is active, the vendor API's are called to drop the contact.

15) The interface translation layer then performs clean-up of storage, contact entries, etc.

16) A Drop Contact is sent to the EMM server verifying the contact has been dropped.

Generic Inbound Contact Flow Chart

FIG. 8 briefly describes the arrival and drop (via agent terminating session) of a contact.

19) The communications technology connector recieves an inbound contact.

20) The connector makes a function call to WorkManager, placing the contact on a queue. WorkManager is responsible for maintaining queues.

30) In this flow chart the agent logs into the system after the work arrival. This need not happen in a given order. An agent can login prior to contact arrival.

40) AgentManager maintains the states of the agent (Ready, busy, wrap-up, etc.) In step 40 the Agent has logged in and the Agent Manager lets the connector know that agent is available on that channel.

50) After login, the AgentManager tells the WorkManager that the agent is available on the given channel and can be logged into the proper queue.

60) Since there is work (a contact) already queued for the agent, a Pending work event is sent to the Agent Manager (60, 60a) so that preparations can be made to deliver the contact (work) to the agent. The Agent manager responds to this event by setting all channel for the given agent to work not ready, so that he will not be delivered a new contact on any channel until the current work (contact) is complete.

70) The WorkmodeChanged event is sent to the Agent Dashboard Manager (via Event Manager—70a) so that it will know to reflect the state change on the agents desktop.

80) In simple terms, the work not ready function call triggers an indicator that alerts the agent that he/she will be receiving a contact (new work).

90) Agent Manager then tells the connector that the work (contact) has been assigned to the Agent.

100) Agent Manager then claims the contact from the WorkManager. This means that the contact will be removed from the channel queue and assigned to the agent.

110) Now that the agent knows work is coming, all channels are aware of the state change, and the work has been removed from the channel queue. Agent Manager then delivers the New Contact event to the Agent Dashboard Manager (110a). This is the first step towards physically delivering the contact (work) to the Agent's desktop.

120) Agent Dashboard will then query the connector for the contact state, so that it is sure the contact (work) has not dropped the connection at their end (caller hangs up phone, user drops web chat session, etc.)

130) Assuming the contact is still available, a Site/Party Identity call is made to the CRM system to get all the information about the contact that is available (translate an e-mail address into a persons Name and what product they have). This is called Contact Associated Data (CAD).

140) The contact is then pushed to the agents desktop by the Add New Contact function call. This creates the screen pop.

150) The Agent then owns the contact and the CRM system is again queried for and updated with any new information or history for this contact as the session progresses. To begin interacting w/the contact the agent will implicitly or manually Answer the contact.

150a) The CRM system the notifies the EMM APP Server that the contact is being answered.

150b) The Multi-Channel RFC is notified and in turn.

150c) Delivers the Contact Answer to the connector.

160) The connector the notifies the Agent Dashboard that the contact state has been updated.

170) The Agent's desktop is then updated via a contact changed call. The agent is now actively engaged and connected to the contact. Activities such as updating contact data occur during the transaction. For purposes of this flow we will pick up when the Agent drops the contact.

180) The agent terminates interaction with the contact either implicitly or manually.

180a) The CRM system the notifies the EMM APP Server that the contact is being dropped.

180b) The Multi-Channel RFC is notified and in turn . . . .

180c) Delivers the Contact Drop to the connector. *** Not shown: Steps 160 and 170 will be repeated for the call drop once the connector ensures the contact is dropped so that the agents application (desktop) will be updated to reflect the contact being dropped.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A method for managing enterprise communications wherein the enterprise receives communications data from a plurality of communications technologies, the method comprising the following steps:
for each communications technology, converting the data from each technology to a common interface data,
managing the interface data including creating a combined queue of communications data from the communications technologies, and
delivering the managed interface data to any application in the enterprise.

2. A method for managing enterprise communications as described in claim 1, wherein the combined queue of communications data is a universal queue of communications data from all communications technologies.

3. A method for managing enterprise communications as described in claim 1, wherein the combined queue of communications data is a combination of queues from similar communications technologies.

4. A method for managing enterprise communications as described in claim 1, wherein the communications technologies comprise different vendor technologies.

5. A method for managing enterprise communications as described in claim 1, wherein the communications technologies comprise similar communications technologies.

6. A method for managing enterprise communications as described in claim 1, wherein each communications technologies has its own queue management functionality before the creation of a combined queue herein.

7. A method for managing enterprise communications as described in claim 1, wherein at least one of the communications technologies does not have its own queue management functionality, and further wherein the step of creating a combined queue includes assigning queue management functionality to each communications technology that does not already have it.

8. A method for managing enterprise communications as described in claim 1, wherein the enterprise comprises a plurality of applications, the method further comprising receiving data from any application in the enterprise and making that data available to one or more of the other applications.

9. A system for managing enterprise communications wherein the enterprise receives communications data from a plurality of communications technologies, the system comprising an enterprise macro-manager, wherein the enterprise macro-manager further comprises
a) communications technology connectors adapted to convert data from each technology to a common interface data,
b) at least one management services module that manages the interface data, and
c) user links adapted to connect the managed data to at least one enterprise application.

10. The system described in claim 9, wherein a management services module creates a combined queue of communications data from the communications technology.

11. The system described in claim 10, wherein the combined queue of communications data is a universal queue of communications data from all communications technologies.

12. The system described in claim 10, wherein the combined queue of communications data is a combination of queues from similar communications technologies.

13. The system described in claim 9, wherein the communications technologies comprise different vendor technologies.

14. The system described in claim 9, wherein the communications technologies comprise similar communications technologies.

15. The system described in claim 10, wherein each communications technologies has its own queue management functionality before the creation of a combined queue herein.
